(19) United States
(12) Patent Application Publication
(10) Pub. No.: US 2009/0083273 A1
(43) Pub. Date: Mar. 26, 2009

(54) PORTABLE ELECTRONIC APPARATUS AND CONTROL METHOD FOR PORTABLE ELECTRONIC APPARATUS

(75) Inventors: Norio Ishibashi, Kawasaki-shi (JP); Atsushi Takahashi, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/205,235

(22) Filed: Sep. 5, 2008

(30) Foreign Application Priority Data
Sep. 20, 2007 (JP) 2007-243257
Mar. 19, 2008 (JP) 2008-071712

(51) Int. Cl. G06F 17/30

(52) U.S. Cl. 707/9; 707/E17.01

(57) ABSTRACT

An IC card has a function for executing a process in a plurality of logical channels. When receiving a command in a certain logical channel, a control section of the IC card determines whether a priority right of an access to a file to be processed by the command is set in another logical channel. When the access priority right is not set in another logical channel, the control section of the IC card gives the access priority of the file to the logical channel which receives the command. The control section of the IC card limits executable command processes for accessing files with set access priority right. The control section of the IC card disables execution of a process which might change data (process for a command) on a file whose access priority right is set in another logical channel.

### CROSS-REFERENCE TO RELATED APPLICATIONS

This application is based upon and claims the benefit of priority from prior Japanese Patent Applications No. 2007-243257, filed Sep. 20, 2007; and No. 2008-071712, filed Mar. 19, 2008, the entire contents of both of which are incorporated herein by reference.

### BACKGROUND OF THE INVENTION

1. Field of the Invention

The invention relates to a portable electronic apparatus such as an IC card containing an IC chip having a control element, a communication interface and a nonvolatile memory, and a control method for the portable electronic apparatus.

2. Description of the Related Art

In general, IC chips in which a control element and various memories are provided into a card-type case made by plastic or the like are implanted into IC cards as portable electronic apparatuses. Various application programs and data files are stored in non-volatile memories in such IC cards. Some of such IC cards have a function of logical channel as a processing method for commands given from external apparatuses. In the IC cards having the logical channel function, different sets of processes can be executed in the respective logical channels in parallel.

For example, in “ISO/IEC7816-4” as the international standard, allowance or disallowance of access to one file in a plurality of different logical channels can be controlled by control information about the file (for example, “ISO/IEC7816-4: 2005 Section 5.3.3”). However, when the access to one file is allowed, accesses such as writing and erase to the file from a plurality of channels are enabled. For this reason, in conventional IC cards, when processes for writing, rewriting, deleting and erasing data of a file, namely, changing a file state is executed in a certain channel, in another channel which accesses to the same file, the process might not be matched with the processes which have been executed.

### BRIEF SUMMARY OF THE INVENTION

It is an object of the present invention to provide a portable electronic apparatus which can controls accesses in a plurality of channels securely and efficiently and a control method for the portable electronic apparatus.

In one embodiment of the present invention, a portable electronic apparatus which executes a process for a command to be given from an external apparatus, comprises: a communication section which communicates with the external apparatus in a plurality of channels; a storage section which stores definition information of a file and a file which is defined by the definition information therein; a setting section which sets information representing a channel having a priority right of an access to the file as the definition information about the file; a first processing section which, when a channel of a command for requesting the access to the file received by the communication section is the channel having the priority right of the access to the file, executes a process requested by the command on the file; and a second processing section which, when the channel of the command for requesting the access to the file received by the communication section is a channel which does not have the priority right of the access to the file, executes a process for only a command whose process contents are permitted under predetermined access limitation.

In one embodiment of the present invention, a control method of a portable electronic apparatus comprises: a communication section which communicates with the external apparatus in a plurality of channels; a storage section which stores definition information of a file and a file which is defined by the definition information therein, and the method of the portable electronic apparatus includes: setting information representing a channel having a priority right of an access to the file as the definition information about the file; executing a process requested by the command on the file when a channel of a command for requesting the access to the file is the channel having the priority right of the access to the file; and executing a process on the file for only a command whose process contents are permitted under predetermined access limitation when the channel of the command for requesting the access to the file is a channel which does not have the priority right of the access to the file.

In one embodiment of the present invention, a portable electronic apparatus comprises: a first storage section which stores an operating system program therein; a second storage section which stores application programs therein; a third storage section which stores data to be used in the application programs stored in the second storage section therein; and a control section which executes the operating system program stored in the first storage section and the application program stored in the second storage section, wherein the operating system program includes: a management function which manages information representing a channel accessing to each file stored in the third storage section; and a providing section which refers to the information managed by the management function so as to provide the information representing the channel accessing to the file to an application which tries to access to a specified file, the application programs include: a determining function which determines accessibility/inaccessibility to the file based on the information provided by the operating system and a channel allocated to the operating system; an interrupting function which, when the determining function determines that the access to the file is disabled, interrupts the access to the file; and an executing function which, when the determining function determines that the access to the file is permitted, executes the access to the file.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiment of the invention, and together with the general description given above and the detailed description of the embodiment given below, serve to explain the principles of the invention.

FIG. 1 is a block diagram schematically illustrating a constitution example of an IC card and an IC card processing apparatus having a function for communicating with the IC card;

FIG. 2 is a block diagram schematically illustrating a hardware structure example of the IC card;

FIG. 3 is a diagram illustrating a file structure example of data to be stored in a nonvolatile memory;

FIG. 4 is a diagram illustrating a structure example of a command;

FIG. 5 is a diagram illustrating a structure example of file control information;

FIG. 6 is a flow chart illustrating a first operation example for various commands;

FIG. 7 is a diagram illustrating an example of a command group to be given to the IC card;

FIG. 8 is a diagram illustrating an operation of the IC card for executing a series of commands shown in FIG. 7 according to the first operation example;

FIG. 9 is a flow chart illustrating a second operation example;

FIG. 10 is a diagram illustrating an operation of the IC card for executing a series of commands shown in FIG. 7 according to the second operation example;

FIG. 11 is a flow chart illustrating a third operation example;

FIG. 12 is a diagram illustrating an operation of the IC card for executing a series of commands shown in FIG. 7 according to the third operation example;

FIG. 13 is a flow chart illustrating a fourth operation example;

FIG. 14 is a diagram illustrating an operation of the IC card for executing a series of commands shown in FIG. 7 according to the fourth operation example;

FIG. 15 is a flow chart illustrating a fifth operation example;

FIG. 16 is a diagram illustrating an operation of the IC card for executing a series of commands shown in FIG. 7 according to the fifth operation example;

FIG. 17 is a pattern diagram illustrating a software structure of the IC card;

FIG. 18 is a diagram illustrating a structure example of a channel management table for managing an access order of the channels;

FIG. 19 is a diagram illustrating a structure example of the channel management table for managing an access order of the channels; and

FIG. 20 is a flow chart explaining a processing example for the commands in the IC card.

### DETAILED DESCRIPTION OF THE INVENTION

An embodiment of the present invention is described below with reference to the drawings.

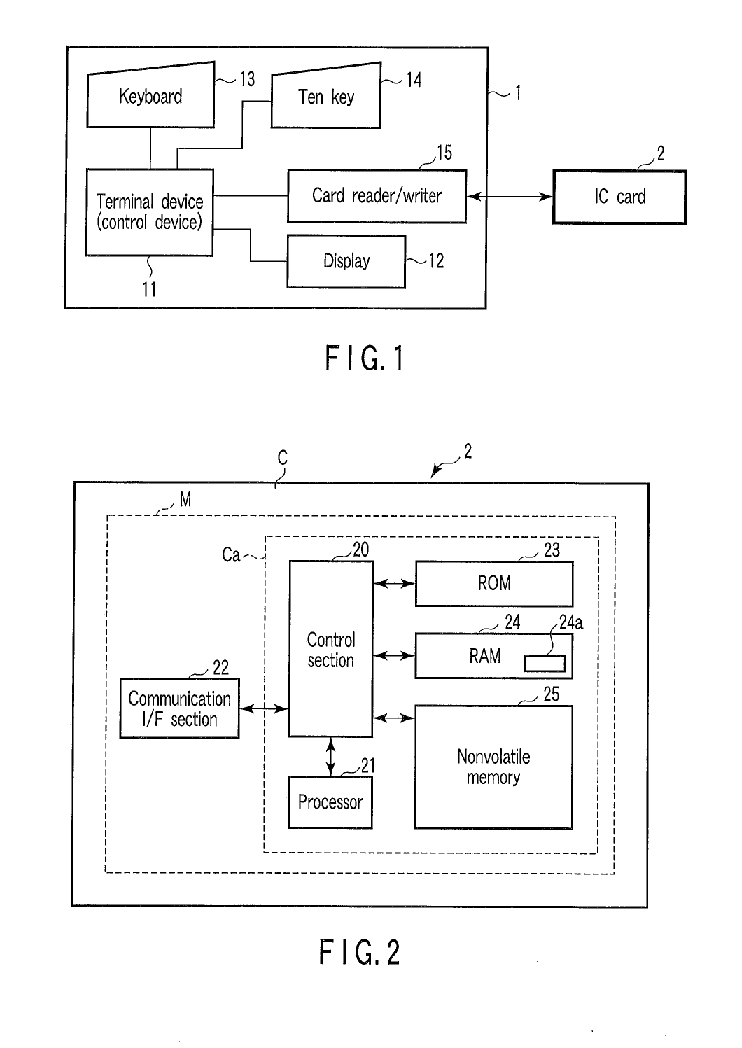

FIG. 1 is a flock diagram schematically illustrating a constitution example of an IC card (portable electronic apparatus) 2 and an IC card processing apparatus 1 as an external apparatus having a function for communicating with the IC card according to an embodiment.

The constitution of the IC card processing apparatus 1 is described below.

As shown in FIG. 1, the IC card processing apparatus 1 has a terminal device 11, a display 12, a keyboard 13, a ten key 14 and a card reader/writer 15.

The terminal apparatus 11 controls an entire operation in the IC card processing apparatus 1. The terminal apparatus 11 is composed of a CPU, various memories and various interfaces. For example, the terminal device 11 is composed of a personal computer (PC).

The terminal device 11 has a function for transmitting a command to the IC card 2 using the card reader/writer 15, and a function for executing various processes based on data received from the IC card 2. For example, the terminal device 11 transmits a data writing command to the IC card 2 via the card reader/writer 15 so as to write the data in a nonvolatile memory in the IC card 2. The terminal device 11 transmits a reading command to the IC card 2 so as to read the data from the IC card 2.

The display 12 is a display apparatus which display various information according to the control of the terminal device 11. The keyboard 13 functions as an operating section which is operated by an operator of the IC card processing apparatus 1, and various operating instructions and data are input by the operator via the keyboard 13. The ten key 14 functions as an input section for inputting information such as user's ID, password or number.

The card reader/writer 15 is an interface apparatus which communicates with the IC card 2. The card reader/writer 15 is composed of an interface according to a communication system of the IC card 2. For example, when the IC card 2 is a contact-type IC card, the card reader/writer 15 is composed of a contact section for the IC card 2 and a contact section for physical and electric connection. When the IC card 2 is a contactless IC card, the card reader/writer 15 is composed of an antenna and a communication control for wireless communication with the IC card 2. In the card reader/writer 15, supply of power source, supply of a clock, reset control and data transmission/reception with respect to the IC card 2 are carried out. With such functions, the card reader/writer 15 activates (actuates) the IC card 2, transmits various commands and receives responses to the transmitted commands to/from the IC card 2 based on the control of the terminal device 11.

A hardware structure example of the IC card 2 is described below.

When receiving supply of an electric power from an higher-level device such as the IC card processing apparatus 1, the IC card 2 is activated (in an operable state). For example, when the IC card 2 is connected to the IC card processing apparatus 1 via the contact-type communication, namely, when the IC card 2 is the contact-type IC card, the IC card 2 is supplied with an operation power and an operation clock from the IC card processing apparatus 1 via the contact section as a communication interface so as to be activated.

When the IC card 2 is connected to the IC card processing apparatus 1 by a contactless communication system, namely, when the IC card 2 is a contactless IC card, the IC card 2 receives a radio wave from the IC card processing apparatus 1 via an antenna and a modulating/demodulating circuit as communication interfaces. The IC card 2 generates an operating power source and an operating clock from the radio wave by means of a power source section (not shown) so as to be activated.

FIG. 2 is a block diagram schematically illustrating a hardware structure example of the IC card 2 according to the embodiment. The IC card 2 contains a module M in an enclosure composing a main body C. The module M is formed integrally in a state that one or a plurality of IC chips Ca and a communication external interface (communication interface) are connected. The module M is embedded into the main body C of the IC card 2. The module M of the IC card 2 has a control section 20, a co-processor 21, a communication interface 22, a ROM 23, a RAM 24 and a nonvolatile memory 25 as shown in FIG. 2.

The control section 20 controls the entire operation of the IC card 2. The control section 20 operates based on control programs and control data stored in the ROM 23 or the nonvolatile memory 25, so as to realize various functions. For example, the control section 20 executes a program of an operating system (OS), so as to control basic operations of the IC card 2. The control section 20 executes application programs so as to control various operations according to operation modes of the IC card 2. The co-processor 21 assists calculations such as encryption or decryption.

The communication interface 22 is an interface for communicating with the card reader/writer 15 of the IC card processing apparatus 1. When the IC card 2 is realized as the contact-type IC card, the communication interface 22 is composed of a communication control section and a contact section which physically and electrically contact with the card reader/writer 15 of the IC card processing apparatus 1 so as to transmit/receive signals. When the IC card 2 is realized as the contactless IC card, the communication interface 22 is composed of a communication control section such as a modulating/demodulating circuit and an antenna for wireless communication with the card reader/writer 15 of the IC card processing apparatus 1.

The ROM 23 is a nonvolatile memory which stores control programs and control data in advance therein. The ROM 23 is incorporated into the IC card 2 in a state that the control programs and the control data are stored at a manufacturing stage. That is to say, the control programs and the control data stored in the ROM 23 are incorporated in advance according to a specification of the IC card 2.

The RAM 24 is a volatile memory which functions as a working memory. The RAM 24 functions as a buffer which temporarily stores data which are being processed by the control section 20. For example, the RAM 24 temporarily stores data received from the IC card processing apparatus 1 via the communication interface 22. A management table for managing various operating states is suitably structured on the RAM 24. For example, logical channels, mentioned later, are managed in a form of current files by a channel management table 24a structured on the RAM 24.

The nonvolatile memory 25 is composed of a nonvolatile memory, such as EEPROM (Electrically Erasable Programmable Read-Only Memory) or a flash ROM into which data can be written or rewritten. Control programs and various data are written into the nonvolatile memory 25 according to operation applications of the IC card 2. A management table which needs to retain data even after no supply of the power source is provided to the nonvolatile memory 25. In the nonvolatile memory 25, program files or data files are defined, and control programs and various data are written into these files. The files to be stored in the nonvolatile memory 25 are defined by file definition information, and data as file main body is stored in a storage area defined by the file definition information.

A structure of data to be stored in the nonvolatile memory 25 is described below.

Various data with file structure defined in ISO/IEC7816, for example, are stored in the nonvolatile memory 25. For example, a file as a data file managed by plural hierarchical structure (tree structure) (EF: Elementary File) and a file as a data folder (DF: Dedicated File) are stored in the nonvolatile memory.

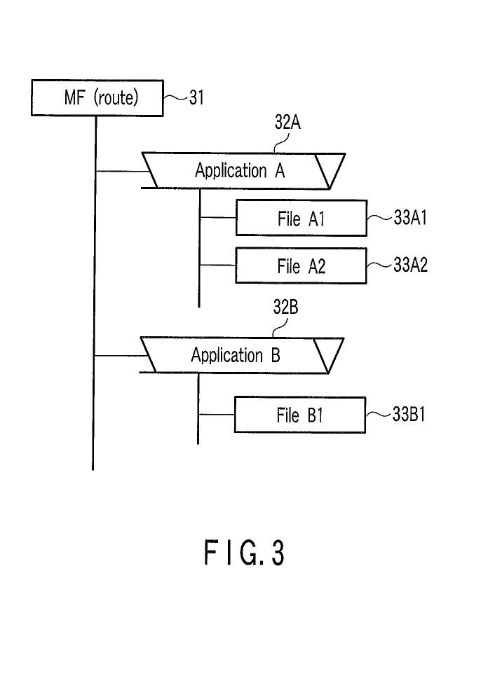

FIG. 3 is a diagram illustrating an example of a file structure stored in the nonvolatile memory 25.

In the example shown in FIG. 3, the top is an MF 31 as a master file. A DF (application A) 32A as a folder and a DF (application B) 32B as a folder are provided under the MF 31. Further, an EF (file A1) 33A1 and an EF (file A2) 33A2 to be used for storage of data are provided under the DF (application A) 32A. An EF (file B1) 33B1 to be used for storage of data is provided under the DF (application B) 32B. In such a file structure, various data are stored in EF as the data file.

The logical channels usable by the IC card 2 are described below.

The IC card 2 has a function for managing accesses of a plurality of logical channels to files. For example, on the logical channels 1 and 2, current files can be set, respectively. The IC card 2 accesses to the current file of the logical channel 1 according to a command given to the logical channel 1. The IC card 2 accesses to the current file of the logical channel 2 according to a command given to the logical channel 2. In other words, the IC card processing apparatus 1 gives various commands, which request accesses to the files in the plurality of logical channels, to the IC card 2, so that the IC card 2 can be allowed to execute process groups in different set of the respective logical channels. The current files of the logical channels are managed by a channel management table 24a structured on the RAM 24 as the working memory.

The logical channels are specified by respective commands.

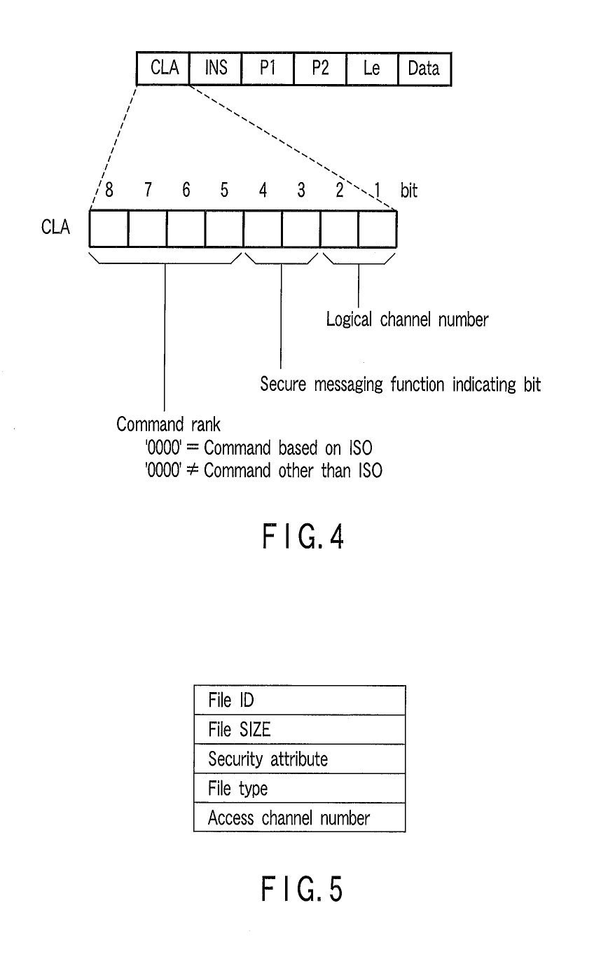

For example, FIG. 4 is a diagram illustrating a structure example of a command defined by ISO/IEC7816-4.

As shown in FIG. 4, the command defined by ISO/IEC7816-4 is composed of “CLA”, “INS”, “P1”, “P2”, “Le” and “DATA”. The logical channel to be used on the command having such a structure is specified by “CLA” (CLA byte, CLA data). In the structure example shown in FIG. 3, the CLA byte of each command is composed of 8 bits. In the CLA byte of each command, a first bit (b1) and a second bit (b2) specify the logical channel (logical channel number) of that command. In such a structure, maximum four logical channels “00” (logical channel “#0”), “01” (logical channel “#1”), “10 (logical channel “#2”), and “11” (logical channel “#3”) can be set in each command.

ISO/IEC7816-4 defines that a desirable logical channel is brought into a usable state by a manage channel command. Normally, a predetermined one logical channel (for example, logical channel “#0”) is always usable. Therefore, when the process is executed without regard to logical channels, various processes are executed on predetermined one logical channel. On the contrary, when a plurality of logical channels are used (for example, logical channels “#1”, “#2” and “#3” are used), the logical channels to be used should be brought into the usable state in advance by the manage channel command. The logical channels are closed according to a predetermined command which requests closing of channels.

File control information included in file definition information of the respective files stored in the nonvolatile memory 25 is described below.

FIG. 5 is a diagram illustrating a structure example of the file control information included in the file definition information.

As shown in FIG. 5, the file control information is composed of information such as “file ID”, “file size”, “security attribute”, “file type” and “access channel number”. “File ID” is identification information for identifying a file”. “File size” is information showing a data size of the file. “Security attribute” is information representing security setting for the file. “Access channel number” is information representing a logical channel to which a priority right of the access to the file is given. “Access channel number” is not always set, and it is occasionally not set. For example, when the process is executed in only one logical channel, “access channel number” does not have to be set.

The priority right (access priority) specified by the access channel number is execution authority of a command which might change data in the file. As the command which might change the data in the file, a command for requesting the rewriting of data, a command for requesting the erase of data, or a command for requesting the deletion of file are assumed. That is to say, when the access channel number is set, the command which might change the data main body of the file is allowed to be executed only in the logical channel to which the priority right is given.

On the contrary, a command which does not change the data main body of a file is allowed to be executed in the respective logical channels regardless of a priority right. As the command which does not change data body of a file, a command for requesting the reading of data or a command for requesting selection of a file are assumed. That is to say, even when the access channel number is set, the command which does not change data main body of a file is allowed to be executed even in logical channels to which a priority right is not given.

A first operation example in the IC card 2 is described below.

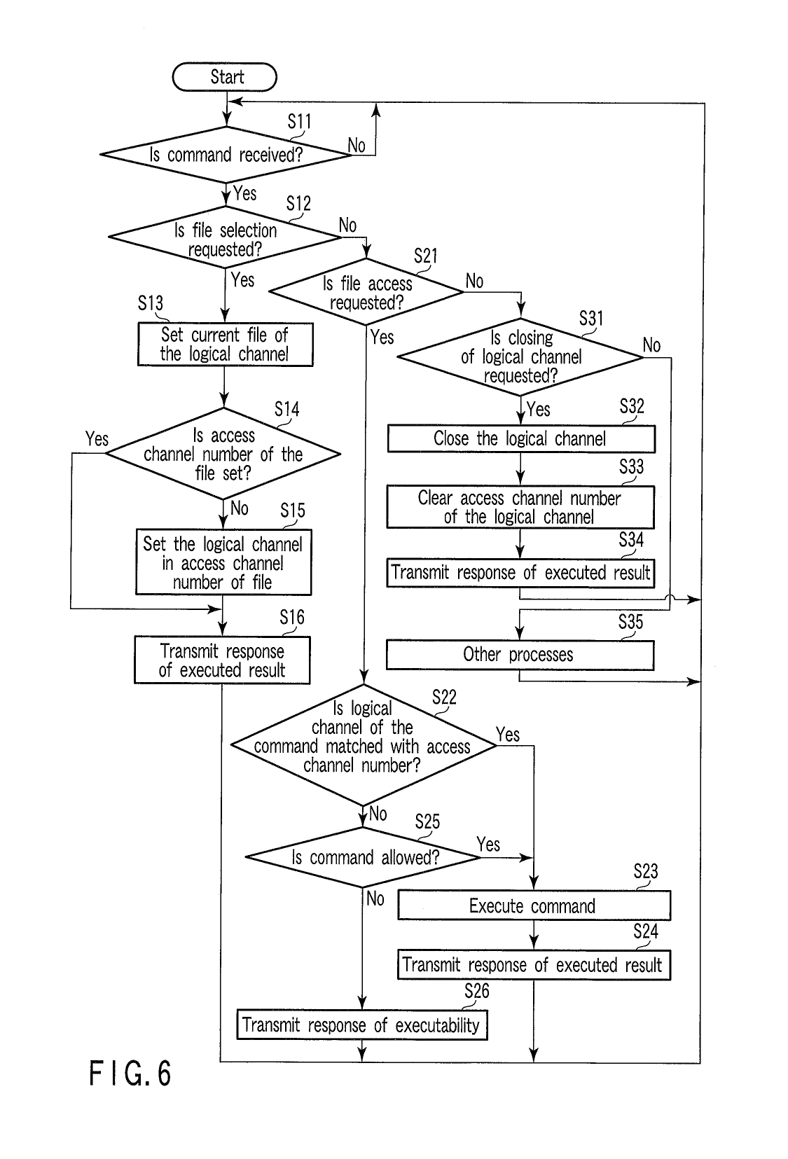

FIG. 6 is a flow chart illustrating the first operation example for various commands received from the IC card processing apparatus 1.

The plurality of channels are in an opened state here.

When receiving a command from the IC card processing apparatus 1 (YES at step S1), the control section 20 of the IC card 2 discriminates process contents of the received command. When the received command is a command for requesting the selection of a current file (the command for requesting setting of a specified file in the current file of the logical channel) (YES at step S12), the control section 20 sets the specified file as the current file in the logical channel of this command (step S13).

When the file specified by the received command is set in the current file of the logical channel, the control section 20 determines whether a logical channel which has a priority right of an access to the file selected as the current file in the logical channel of the received command is already set (step S14). In the process at step S14, for example, the control section 20 determines whether an access channel number is set in the file control information about this file.

When the determination is made that the logical channel which has the priority right of the access to the selected file is not set (NO at step S14), the control section 20 sets the priority right of the access to the file in the logical channel of this command (step S15). The priority right of the access to the file is set by adding information representing the logical channel as the access channel number to the file control information of the file.

When the determination is made that the logical channel which has the priority right of the access to the selected file is already set (YES at step S14), or when the process for setting the access priority right at step S15 is completed, the control section 20 transmits the normal end of current file setting as the response to the received command to the IC card processing apparatus 1 (step S16).

When the received command is a command for requesting an access to a file (for example, a command for requesting data reading, data writing, data erase or file deletion) (YES at step S21), the control section 20 determines whether the logical channel of the received command is matched with the access channel number set in the current file (file to be accessed) if the logical channel (step S22). As the process at step S22, the control section 20 determines whether the priority right of the access to the current file is given to the logical channel.

When the determination is made that the logical channel of the received command is matched with the access channel number of the current file of this logical channel, namely, that the logical channel has the priority right of the access to the current file (YES at step S22), the control section 20 executes a process according to the received command (step S23). When the process for the received command is ended, the control section 20 transmits the processed result as the response to the received command to the IC card processing apparatus 1 (step S24).

When the determination is made that the logical channel of the received command is not matched with the access channel number of the current file in the logical channel, namely, that the logical channel does not have the priority right of the access to the current file (NO at step S22), the control section 20 determines whether the process contents of the received command are allowed to be executed (step S25). The access by means of the access priority right is limited on the logical channel where the access priority right is not set so that the a command for requesting a process which might change data main body in a file cannot be executed. The command of data rewriting, data erase or file deletion is limited so as not to be executed in the logical channel where the access priority right is not set. On the contrary, a command for requesting a process which does not change data main body in a file can be executed even in the logical channel where the access priority right is not set. For example, the command for reading data is allowed to be executed on the logical channel where the access priority right is not set.

When the determination is made that the received command can be executed (YES at step S25), the control section 20 executes the received command (step S23). When the process for the received command is completed, the control section 20 transmits the processed result as a response to the IC card processing apparatus 1 (step S24). When the determination is made that the received command cannot be executed (NO at step S25), the control section 20 does not execute the received command, and transmits non-executability of the received command because of the logical channel without the priority right of the access to the file as the response to the received command to the IC card processing apparatus 1 (step S26).

When the received command is a command for requesting closing of a logical channel (YES at step S31), the control section 20 closes the logical channel specified by the received command (step S32). When the logical channel is closed, the control section 20 clears an access channel number in the file control information of each file where the access priority right is set in the logical channel (step S33). When these processes are completed, the control section 20 transmits a normal end of the closing of the logical channel as the response to the received command to the IC card processing apparatus 1 (step S34).

As to the commands other than command for requesting the file selection, the command for requesting the access to a file, and the command for requesting the closing of a logical channel, the control of access to a file in each logical channel should not be taken into consideration. For this reason, the control section 20 executes processes according to the process contents of the commands other than the command for requesting the file selection, the command for requesting the access to a file and the command for requesting the closing of a logical channel (step S35).

A concrete operation example in the IC card 2 to which the first operation example is applied is described below.

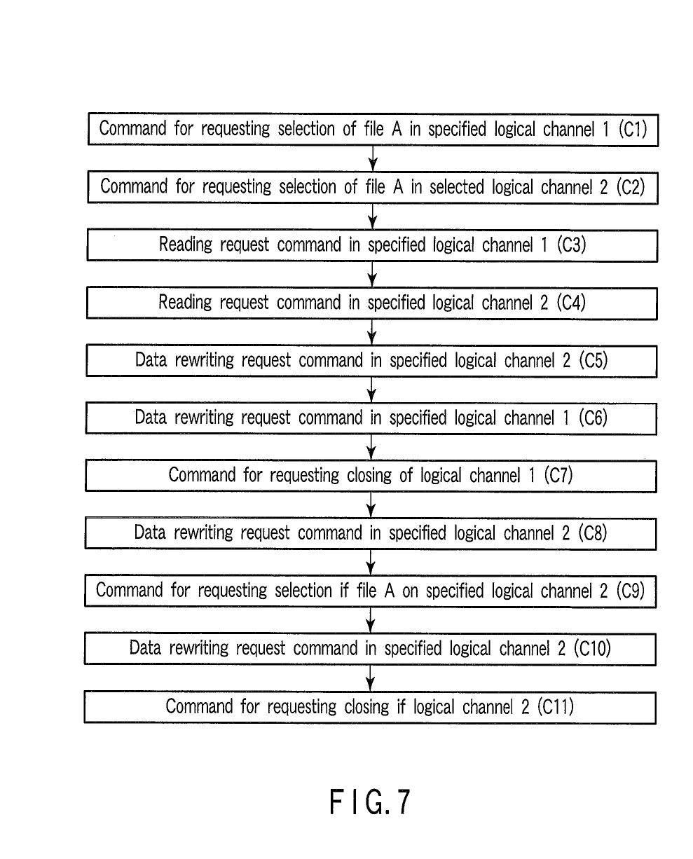

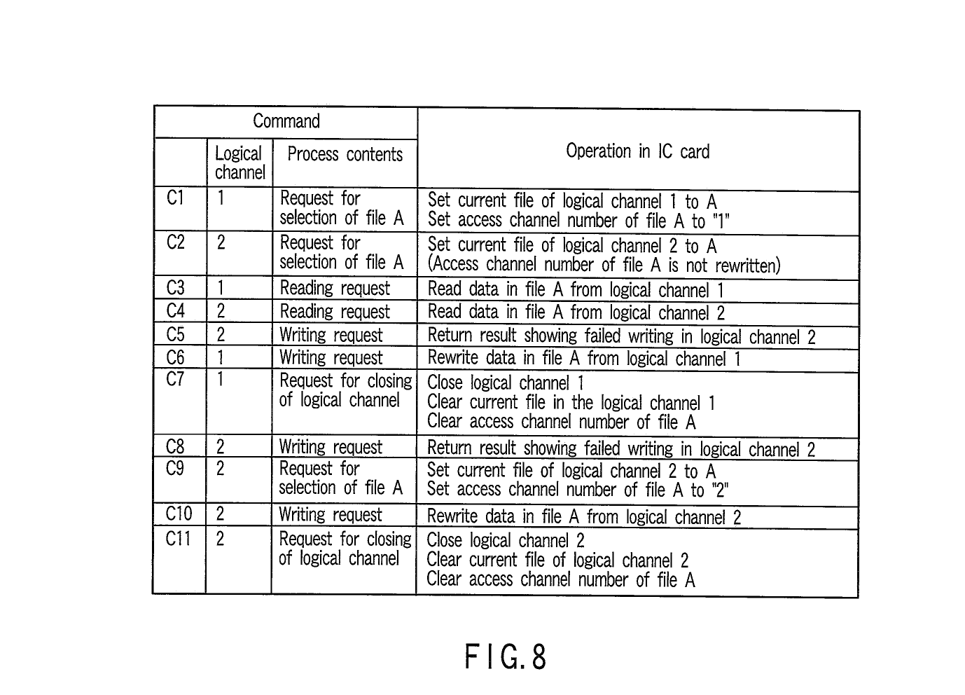

FIG. 7 is a diagram illustrating an example of command groups C1 to C11 to be given to the IC card 2. FIG. 8 is a diagram describing the operations to be performed for a series of commands shown in FIG. 7 by the IC card 2 according to the first operation example. The commands shown in FIG. 7 are a series of commands to be given to the IC card 2 where the logical channels 1 and 2 are opened.

When receiving a selection request command C1 of a file A where the logical channel 1 is specified, the control section 20 of the IC card 2 executes the process at step S12 to 16. That is to say, the control section 20 sets the file A as a current file of the logical channel 1, and checks if an access channel number is set in the file A. At this time, when the access channel number is not set in the file A, the control section 20 sets “1” representing the logical channel 1 as the access channel number of the file A.

When receiving the selection request command C2 of the file A where the logical channel 2 is specified, the control section 20 executes the process at step S12 to S16. In this case, “1” is already set as the access channel number in the file A. For this reason, the control section 20 only sets the file A as the current file of the logical channel 2, so as to prevent rewriting of the access channel number of the file A.

When receiving the command C3 for requesting reading in the specified logical channel 1, the control section 20 executes a process for reading the file A as the process at step S21 to S26. This is because the logical channel 1 has the priority right of the access to the current file (file A). Therefore, the control section 20 reads the data in the file A, and transmits the read data as response data of the command C3.

Also when receiving the command C4 for requesting reading in the specified logical channel 2, the control section 20 executes the process for reading the file A. In this case, the logical channel 1 has the priority right of the access to the current file (file A) in the logical channel 2. However, the reading command can be executed without the access priority right. For this reason, the control section 20 executes the reading process on the file A according to the reading request command C4. That is to say, the control section 20 determines that the execution of the command C4 is allowed. The control section 20 reads the data in the file A based on the determination, and transmits the read data as response data of the command C4.

When receiving the command C5 for requesting data writing in the specified logical channel 2, the control section 20 does not allow the execution of the command C5 as the process at steps S21 to S26. In this case, the logical channel “1” has the priority right of the access to the current file (file A) in the logical channel 2. The data writing request command is a non-executable command when the access priority right is not given. Therefore, the control section 20 determines that the process according to the command C5 is non-executable. The control section 20 transmits the non-executability of the command C5 as a response of the command C5 based on the determination.

When receiving the command C6 for requesting data writing in the specified logical channel 1, the control section 20 executes the command C6. In this case, the logical channel “1” has the priority right of the access to the current file (file A) in the logical channel 1. Therefore, the control section 20 rewrites the data in the file A according to the process contents specified by the command C6, and transmits the processed result as a response of the command C6.

When receiving the command C7 for requesting closing of the logical channel 1, the control section 20 executes a process for closing the logical channel 1 as the process at steps S31 to S34. In this case, the control section 20 closes the logical channel 1 and clears the setting of the current file in the logical channel 1, and clears the access channel number of the file A whose access priority right is given to the logical channel. As a result, the priority right of the access of the logical channel 1 to the file A is cleared. The priority right of the access to the file A is not given to any logical channels.

In this state, when receiving the command C8 for requesting data writing in the specified logical channel 2, the control section 20 does not allow the execution of the command C8 as the process at steps S21 to S26. In this case, a logical channel having the access priority right is not set for the current file (file A) in the logical channel 2. In the first operation example, even when the access channel number is not set, the control section 20 determines that the data writing process is not non-executable. Therefore, the control section 20 transmits the non-executability of the command C8 as a response of the command C8.

When receiving the command C9 for selection of the file A in the specified logical channel 2, the control section 20 executes the process for setting the file A as the current file of the logical channel 2 and setting the access channel number of the file A to the logical channel “2” as the process at steps S12 to S16. In this case, when receiving the request of the selection of the file A, an access channel number is not set for the file A. That is to say, when the logical channel 1 having the priority right of the access to the file A is closed, the access channel number of the file A is cleared. For this reason, the control section 20 gives the priority right of the access to the file A to the logical channel 2 according to the request for the selection of the file A received by the logical channel 2 after the logical channel 1 is closed. In other words, in the first operation example, when the command for requesting the selection of the file A is received after the logical channel 1 to which the access priority right is given is closed, the priority right of the access to the file A is given to the logical channel 2 to which the priority right of the access to the file A is not given. The priority right of the access given to a logical channel is maintained until the logical channel is closed. Therefore, in the logical channel selected at first as the current file, various command for the access to the file are allowed. However, in the other logical channels, the access to the file is limited. As a result, even when a request of the process for the access to a specified file in a plurality of logical channels (command) is received, the consistency of respective processes can be maintained.

A second operation example in the IC card 2 is described below.

In the second operation example, in addition to the first operation example, when the access priority right is given to the other channels, limitation of the executable commands is posted to the IC card processing apparatus (command transmission source) 1. The limitation of the executable commands can be posted as a response to any command. When the priority right of the access to the file selected by the file selection request command is given to another logical channel, the limitation of the command for the selected file in the logical channel of the command is posted.

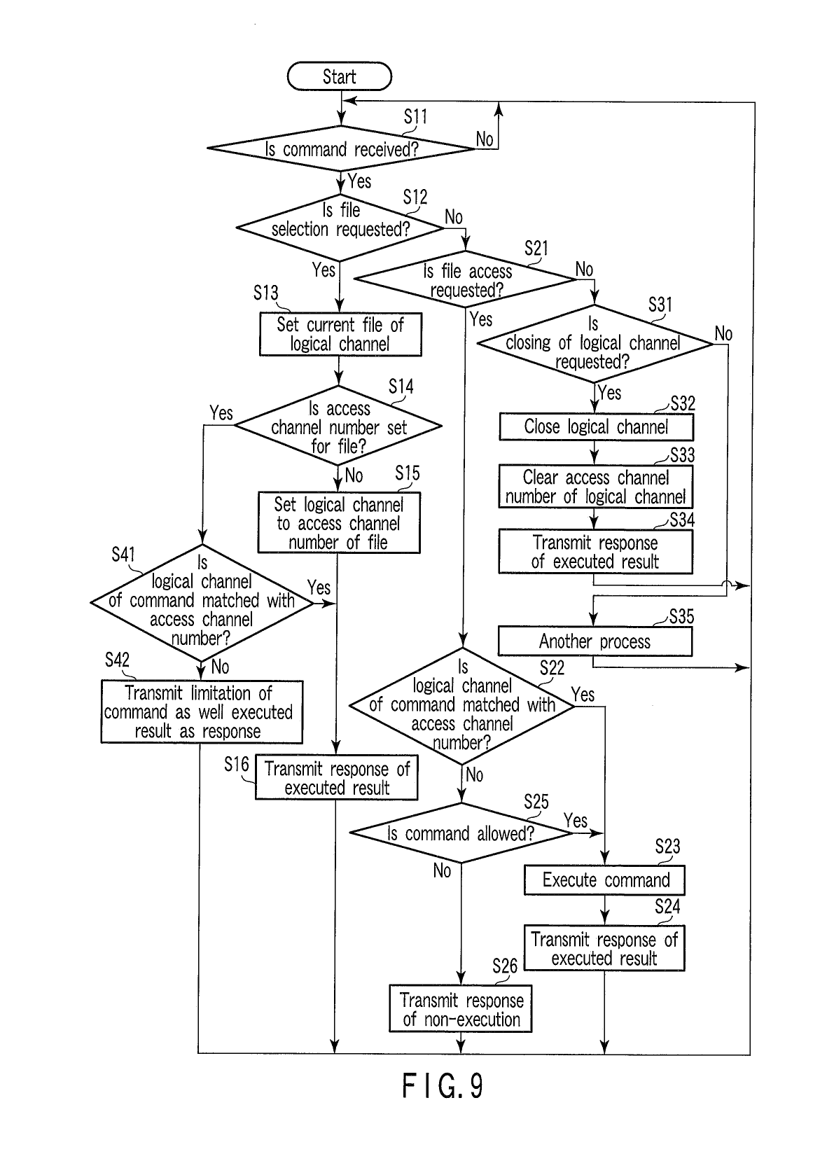

FIG. 9 is a flow chart describing the second operation example.

The second operation example shown in FIG. 9 is such that steps S41 and S42 are added to the first operation example shown in FIG. 6. Therefore, since respective steeps except for steps S41 and S42 shown in FIG. 9 are similar to those shown in FIG. 6, their detailed description is omitted.

That is to say, at step S14, when an access channel number is already set for a file selected as a current file according to the received file selection request command (YES at step S14), the control section 20 determines whether the logical channel of the command is matched with the access channel number of the selected file (step S41). When the determination is made that the logical channel of the file selection request command is matched with the access channel number of the selected file (YES at step S41), the control section 20 goes to step S16 so as to transmit a response showing normality to the IC card processing apparatus 1.

On the contrary, when the determination is made that the logical channel of the file selection request command is not matched with the access channel number of the selected file (NO at step S41), the control section 20 transmits limitation of the executable command for the selected file in the logical channel as a response of the command as well as the processed result of the command to the IC card processing apparatus 1 (step S42). In this case, the control section may post not only the limitation of the executable commands but also information representing a command to be non-executable (or a command whose execution is allowed) as a response.

A concrete operation example in the IC card 2 to which the second operation example is applied is described below.

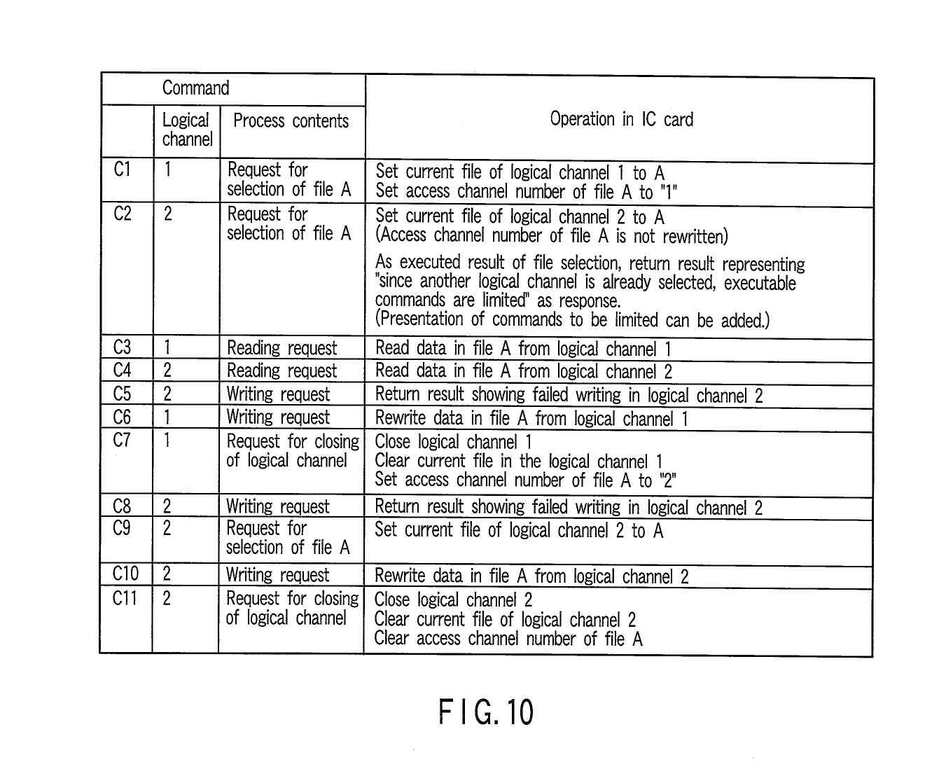

FIG. 10 is a diagram illustrating an operation to be executed by the IC card 2 for a series of commands shown in FIG. 7 according to the second operation example. Since the operations of the commands other than the command C2 shown in FIG. 7 are similar to the first operation example, their detailed description is omitted.

That is to say, the access channel number of the file A is set to “1” representing the logical channel 1 according to the selection request command C1 for the file A in the specified logical channel 1. When receiving the selection request command C2 for the file A in the specified logical channel 1, the control section 20 sets the file A as a current file of the logical channel 2, and checks if the “1” is already set as the access channel number to the file A as the process at steps S12 to S16, S41 and S42. In this case, the control section 20 already sets “1” as the access channel number to the file A. For this reason, the control section 20 transmits limitation of executable commands in the logical channel 2 as well as the process executed result as a response of the command C2.

In the IC card of the second operation example, when the current file is set according to the file selection request command received by a certain logical channel, and the priority right of the access to the file is given to another logical channel different from the logical channel of the command, the limitation of the executable commands for the file in the logical channel of the command is posted.

A third operation example in the IC card 2 is described below.

In the third operation example, in addition to the first operation example, when the logical channel to which the priority right of the access to a specified file is given is closed, the file access priority right is transferred to another logical channel (for example, another logical channel where this file is selected as a current file).

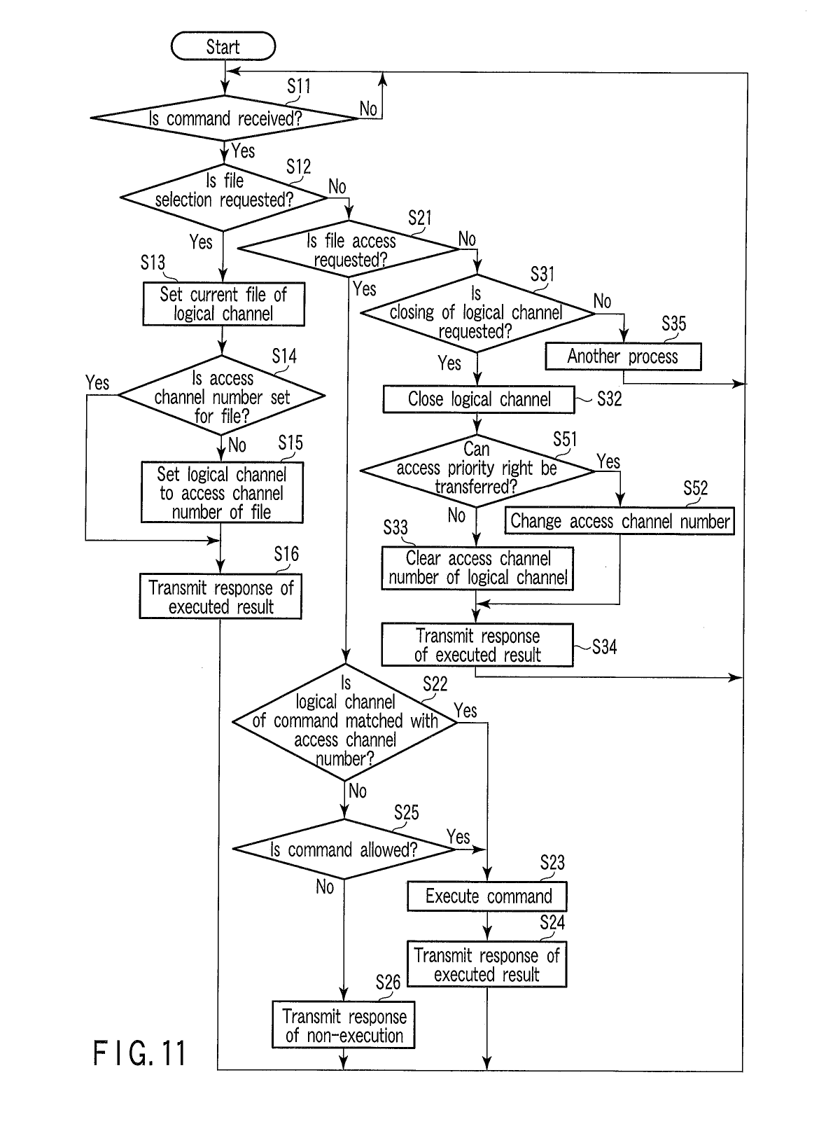

FIG. 11 is a flow chart describing the third operation example.

In the third operation example shown in FIG. 11, steps S51 and S52 are added to the first operation example shown in FIG. 6. Therefore, since respective steps other than steps S51 and S52 shown in FIG. 11 are similar to the steps shown in FIG. 6, their description is omitted.

The control section 20 closes a certain logical channel at step S32. In this case, the control section 20 determines whether the access priority right given to the logical channel to be closed can be transferred to another logical channel (step S51). That is to say, the control section 20 executes a process for detecting a file in the logical channel to be closed to which the access priority right is given. When the file in the logical channel to be closed to which the access priority right is given is detected, the control section 20 determines whether the detected file is selected in another selection channel. When the determination is made that the logical channel in which the file in the logical channel to be closed having the access priority right is selected is present, the control section 20 determines that the access priority right can be transferred.

When the determination is made that the file in the logical channel to be closed having the access priority right is selected in another logical channel, the control section 20 rewrites the access channel number in the file control information about this file into another logical channel determined that this file is selected (step S52). As a result, the access priority right of the file whose access priority right is set for the logical channel to be closed is transferred to another logical channel from the logical channel to be closed to another logical channel where the file is selected.

When the determination is made that the access priority right given to the logical channel to be closed cannot be transferred (for example, the file whose access priority right is given to the logical channel to be closed is not selected in another logical channel), the control section 20 clears the access channel number in the file information about this file (information representing the logical channel to be closed) (step S33).

A concrete operation example in the IC card 2 to which the third operation example is applied is described below.

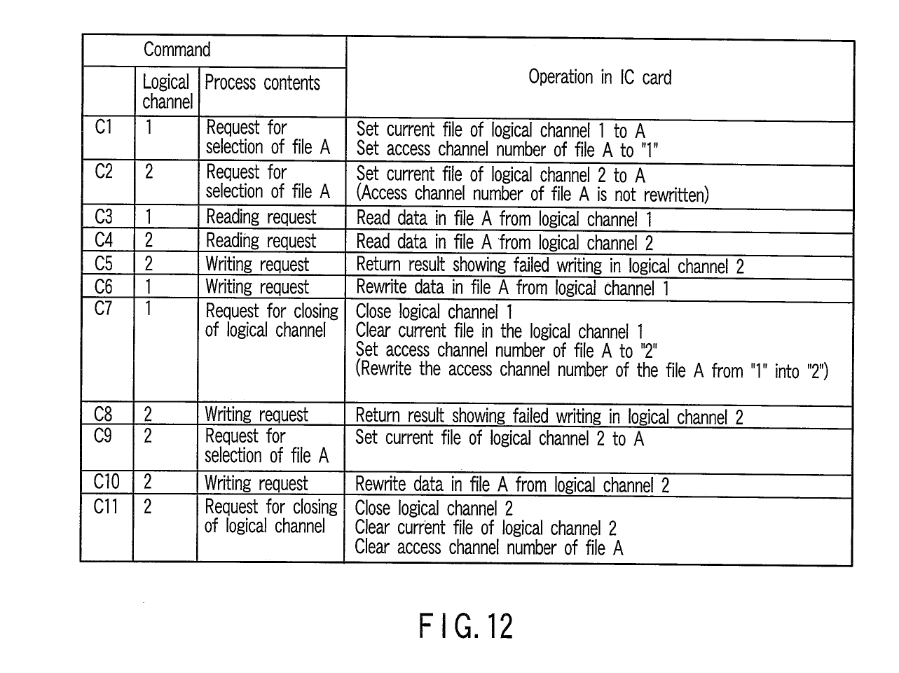

FIG. 12 is a diagram describing an operation to be performed on a series of commands shown in FIG. 7 by the IC card 2 according to the third operation example. Since the operations on the commands other than command C7 shown in FIG. 7 are similar to the operation in the first operation example, their detailed description is omitted.

That is to say, the access channel number of the file A is set to “1” representing the logical channel 1, and the current file of the logical channel 2 is set to the file A. In this state, when receiving the command C7 for requesting the closing of the logical channel 1, the control section 20 closes the logical channel 1 and rewrites the access channel number of the file A from “1” into “2” as the process at steps S31 to S34, S51 and S52.

In the IC card according to the third operation example, when the logical channel is closed, the access priority right of the file given to the logical channel is transferred to another logical channel where this file is selected. As a result, when the logical channel having the access priority right is closed, the access priority right of the file is automatically given to another logical channel where the file is selected without again executing the file selecting command.

A fourth operation example in the IC card 2 is described below.

In the fourth operation example, in addition to the first operation example, information about a file whose access priority right is acquirable is posted to the IC card processing apparatus (command transmission source) 1. The information about the file whose access priority right is acquirable can be posted as a response of any command. In the following description, the following operation is mainly assumed. That is to say, when a command (for example, the data rewriting command) cannot be executed because the access priority right is not set, acquirability of the access priority right of this file in the logical channel of this command is posted as a response of the command.

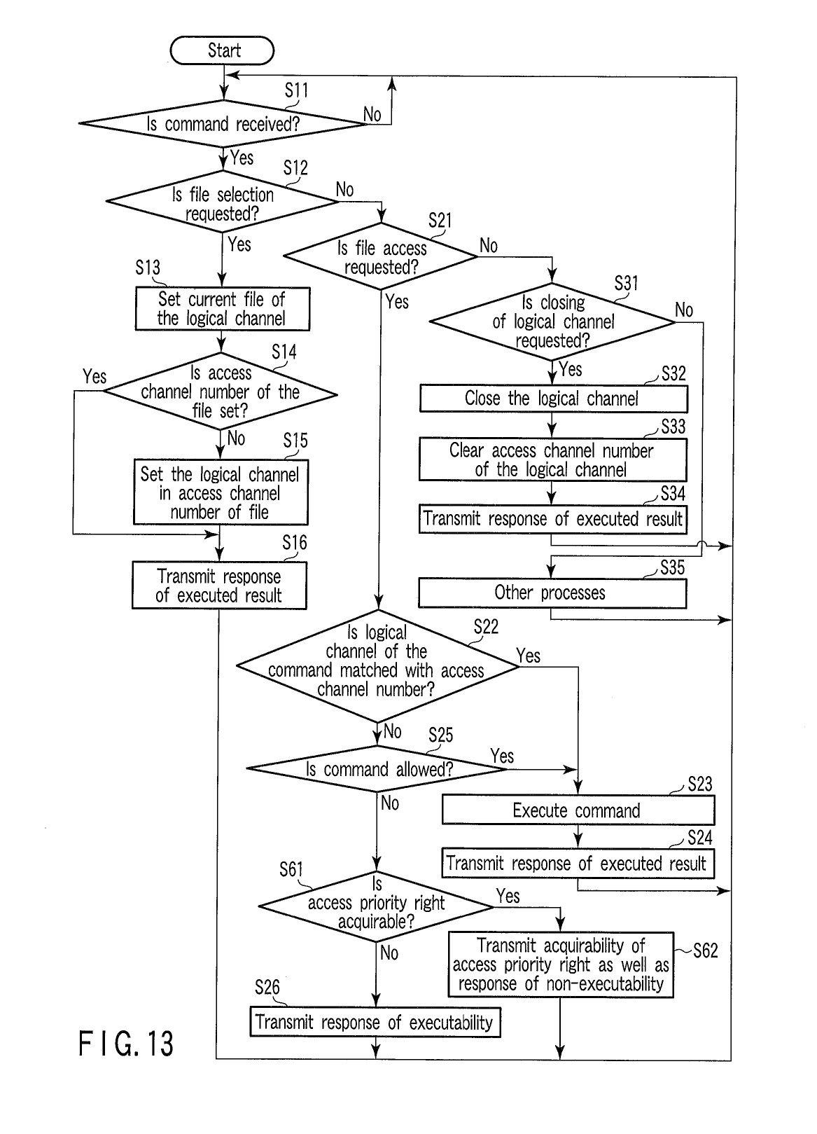

FIG. 13 is a flow chart describing the fourth operation example.

In the fourth operation example shown in FIG. 13, steps S61 and S62 are added to the first operation example shown in FIG. 6. Therefore, since the steps other than steps S61 and S62 shown in FIG. 13 are similar to the steps shown in FIG. 6, their detailed description is omitted.

That is to say, when a determination is made at step S25 that since the access priority right is not set in the logical channel of a received command, the receiving command is non-executable, the control section 20 determines whether the access priority right of the file to be executed by the received command can be acquired in the logical channel of the received command (step S61). The control section 20 can determine whether the access priority right to this file can be acquired in the logical channel of the received command by determining whether the access channel number is set in the file control information about this file.

When the determination is made that the access priority right can be acquired in the logical channel of the received command (YES at step S61), the control section 20 transmits non-executability of the received command as well as information that the access priority right of the file can be acquired in the logical channel as a response of the received command to the IC card processing apparatus 1 (step S62). When the determination is made that the access priority right cannot be acquired (NO at step S61), the control section 20 may transmit the non-executability of the received command as well as information representing the logical channel where the access priority right of the file is set.

A concrete operation example in the IC card 2 to which the fourth operation example is described below.

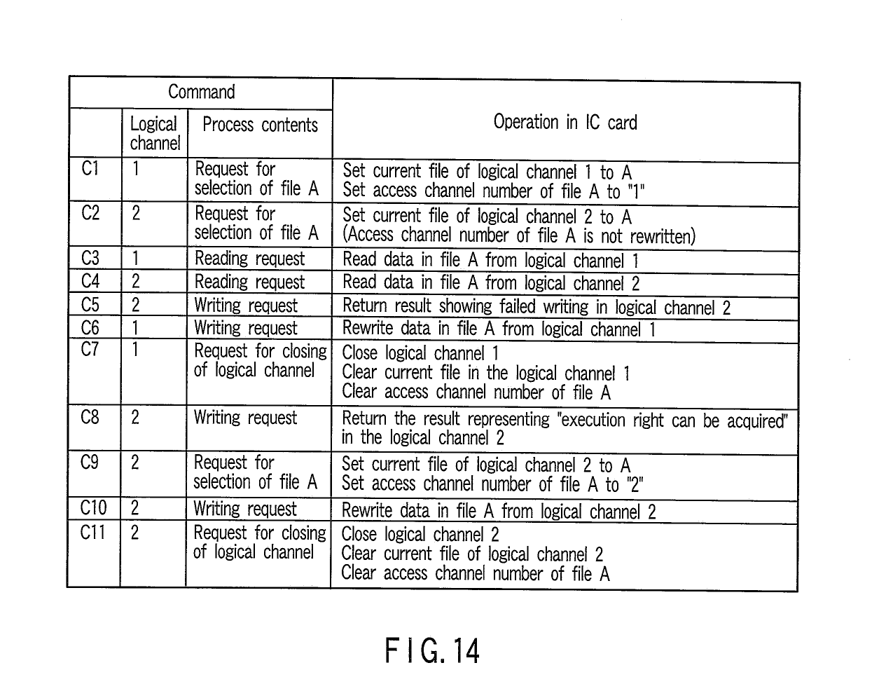

FIG. 14 is a diagram for describing an operation to be performed on a series of command shown in FIG. 7 by the IC card 2 according to the fourth operation example. Since the operations for the commands other than the command C8 shown in FIG. 7 are similar to the first operation example, the detailed description thereof is omitted.

That is to say, when the logical channel 1 is closed according to the command C7, the access channel number of the file A whose access priority right is given to the logical channel 1 is cleared. In this state, when receiving the writing request command C8 for data in the specified logical channel 2, the control section 20 makes the execution of the command C8 disabled as the process at steps S21 to S26. This is because the access channel number of the current file (file A) in the logical channel 2 is not set to “2” (logical channel 2).

In the fourth operation example, when the command C8 is made to be non-executable, the control section 20 determines whether the access channel number of the file A to be processed by the command C8 is not yet set. The access channel number of the file A is cleared at the time point of receiving the command C8. For this reason, the control section 20 transmits the non-executability of the command C8 because of not having the access priority right as well as acquirability of the access priority right of the file A in the logical channel as a response of the command C8 to the IC card processing apparatus 1.

In the IC card according to the fourth operation example, as a command which is made to be non-executable because of no access priority right, when the access channel number of the file to be processed by this command is not yet set, non-executability of the command and acquirability of the access priority right of the file are transmitted as response. As a result, even when the access priority right is not desired to be automatically transferred unlike the third operation example, the state whether the access priority right is acquirable or not can be suitably posted to the IC card processing apparatus, thereby providing the efficient process.

A fifth operation example in the IC card 2 is described below.

In the fifth operation example, in addition to the first operation example, at the process in the logical channel without the access priority right of the file, information representing a change in the file due to the command in another logical channel (logical channel having the access priority right) is posted to the IC card processing apparatus (command transmission source) 1. The information representing the state change of the file can be posed as response of any command in the logical channel without the access priority right of the file. When a command (for example, the data rewriting command) cannot be executed because the access priority right is not set, and the data in the file to be accessed by the command is changed by the command in another logical channel, this is posted as the response of the command.

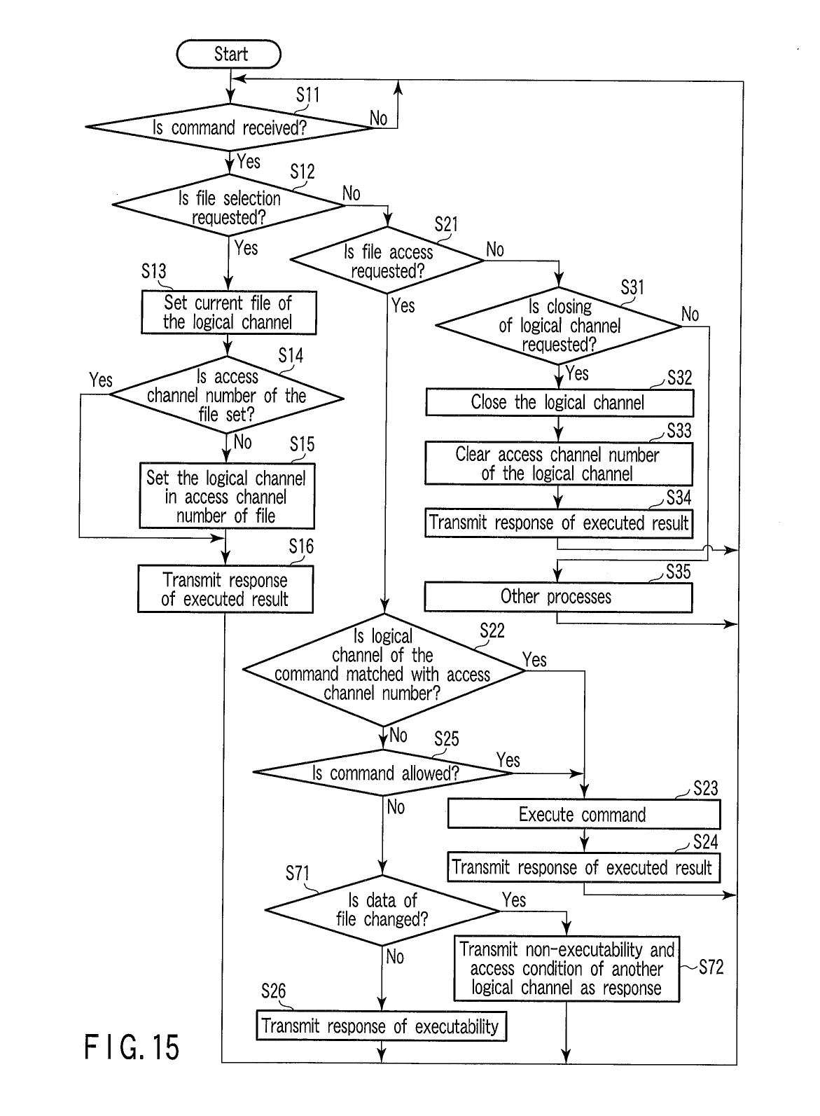

FIG. 15 is a flow chart describing the fifth operation example.

In the fifth operation example shown in FIG. 15, steps S71 and S72 are added to the first operation example shown in FIG. 6. Therefore, since steps other than steps S71 and S72 shown in FIG. 15 are similar to steps shown in FIG. 6, their detailed description is omitted.

When the determination is made at step S25 that the received command is non-executable because the access priority right of the file is not set in the logical channel of the received command, the control section 20 determines whether a process which causes a change in data in the file to be processed by the received command is executed in another logical channel (logical channel having the access priority right) (step S71). This is the determination whether the file to be accessed by the command might be changed by the process in another logical channel. That is to say, the control section 20 determines whether the process which might cause a change in the data in the file to be accessed by the command is executed by the command in the logical channel having the access priority right.

The determination is made that the process which might change the data of the file to be accessed by the received command is executed in another logical channel (YES at step S71), the control section 20 transmits non-executability of the command and information that the process which might change the data in the file is executed in another logical channel as response of the received command to the IC card processing apparatus 1 (step S72). When the determination is made that the process which changes the data in the file to be accessed by the received command is not executed in another logical channel (NO at step S71), the control section 20 may transmit information that the command is non-executable and information that the process which might change the data is not processed on the file as response of the received command.

In order to realize the above process, when at least a command which might change data is executed on the file having the access priority right (or file where an access channel number is set), the process contents are stored in a storage section such as the RAM 24. This is realized by storing the executed process contents stored in the RAM 24 as the command process at step S23.

A concrete operation example in the IC card 2 to which the fifth operation example is applied is descried below.

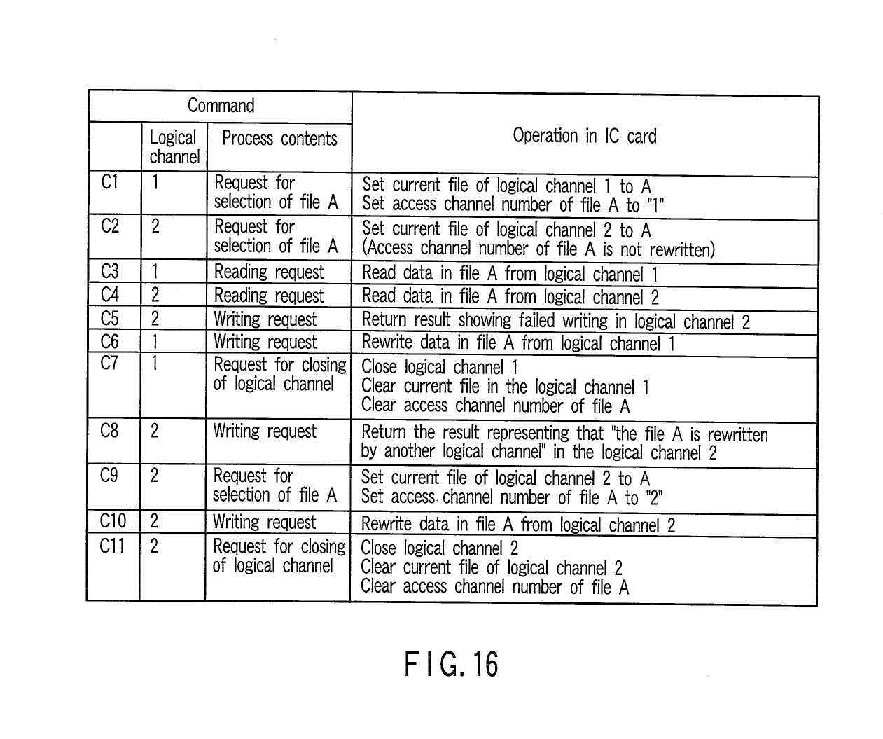

FIG. 16 is a diagram describing the operation to be performed on a series of commands shown in FIG. 7 by the IC card 2 according to the fifth operation example. Since the operations of the commands other than the command C8 shown in FIG. 7 are similar to the operations in the first operation example, their detailed description is omitted.

That is to say, the data rewriting process is executed on the file A in the logical channel 1 having the priority right of the access to the file A according to the command C6. In this state, when receiving the data writing request command C8 in the specified logical channel 2, the control section 20 makes the command C8 non-executable as the process at steps S21 to S25. This is because the access channel number of the current file (file A) in the logical channel 2 is not set to “2” (logical channel 2).

In the fifth operation example, when the command C8 is made to be non-executable, the control section 20 determines whether a command which might change the data is executed on the file A to be processed by the command C8 in another logical channel. The process for rewriting data of the file A is already executed in the logical channel 1 as the process of the command C6 at the time point of receiving the command C8. For this reason, the control section 20 transmits information that the command C8 is non-executable because of no access priority right and information that the data rewriting process is executed on the file A in another logical channel as response of the command C8 to the IC card processing apparatus 1.

In the IC card of the fifth operation example, when the command is made to be non-executable due to no access priority right, and a command which might change data is already executed on the file to be processed by the command in another logical channel (logical channel having the access priority right), non-executability of the command and information that a command which might change data is already executed on the file in another logical channel are transmitted as response. As a result, in the IC card, the process contents executed on the file on which executable command are limited in logical channels without access priority right in another logical channel having the access priority right can be suitably posted to the IC card processing apparatus. Thus, the efficient process is enabled.

The first to fifth operation examples are applied to the portable electronic apparatus such as the IC card 2 having the function for executing processes on a plurality of logical channels. That is to say, when the portable electronic apparatus such as the IC card 2 receives a command in a certain logical channel, and the priority right of the access to the file to be accessed by the command is not set in another logical channel, the access priority right of the file is given to the logical channel which receives the command. The priority rights of the access to the files given to the respective logical channels are maintained until the logical channels are closed. The portable electronic apparatus such as the IC card 2 where such access priority rights are set disables the execution of a process which might change the data of the file (process for the command) according to the command received by another logical channel without access priority right.

In the portable electronic apparatus such as the IC card, even when a request of the process for accessing to a specified file is received by a plurality of logical channels, the consistency of the processes in the respective logical channels can be maintained.

The process in the IC card 2 is described in detail below.

In the IC card 2, the control section 20 executes the data process or the control process of the respective sections. The control section 20 runs programs (software) stored in the ROM 23 or the nonvolatile memory 25 so as to realize the various processes. That is to say, in the IC card 2, the ROM 23, the RAM 24, the nonvolatile memory 25, the communication interface 22 or the co-processor 21 is controlled by software operated by the control section 20, so that the various processes are realized.

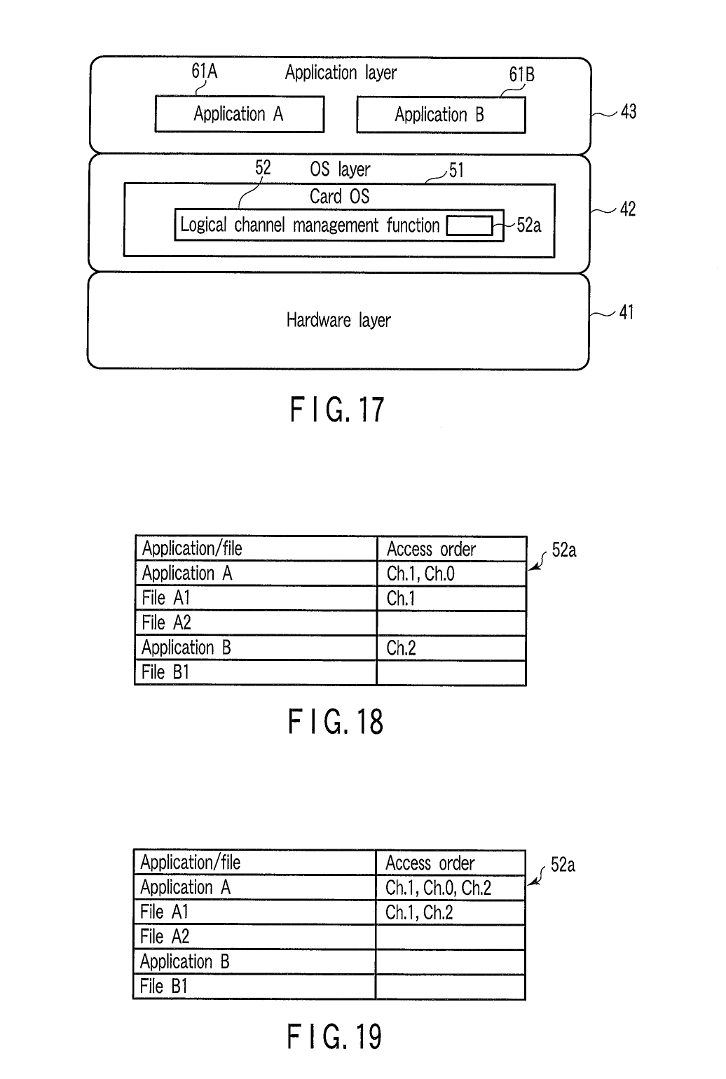

FIG. 17 is a diagram schematically illustrating a software structure in the IC card 2.

A model of the data processing system in the IC card 2 is composed of a hardware (H/W) layer 41, an OS (operating system) layer 42, and an application layer 43. As shown in FIG. 17, in the IC card 2, the application layer 43 is in the highest level, and the OS layer 42 is in a position higher than the H/W layer 41.

The H/W layer 41 is composed of hardware such as the control section 20, the ROM 23, the RAM 24, the communication interface 22, the co-processor 21 and the nonvolatile memory 25. Each hardware of the H/W layer 41 executes a process according to a process request from the OS layer 42 or transmits an executed process result to the OS layer 42.

The OS layer 42 has a card OS (operating system) 51 as a program for executing basic control in the IC card 2. The OS layer 42 may have an environment setting module, or a module such as application interface group. The software as the card OS 51 is a program which controls the basic operation of the IC card. The card OS 51 is a program which controls the hardware of the H/W layer 41 and runs after the information such as the process result is received from the hardware. The card OS 51 is stored in the non-volatile memory in the IC card in advance. The card OS 51 is stored in the ROM 23 or the like.

The card OS 51 has the basic functions for controlling the hardware of the H/W layer for realizing the basic operations of the IC card 2, and further has a logical channel management function 52 for realizing the functions of the logical channels. The logical channel management function 52 manages the logical channels using the channel management table 52a. In the IC card 2, plural sets of commands can be processed in the plurality of channels by the functions of the logical channels. For example, the command process is executed in the first channel by the application A, and the command process is executed in the second channel by the application B.

The application layer 43 includes various application programs (application A, application B, . . . ) as the programs for realizing the various processes. The applications are composed of programs and data for realizing the various processes according to the operation modes of the IC card 2. The applications are stored in the nonvolatile memory 25 of the IC card 2 in advance, or are suitably downloaded from external apparatuses so as to be stored in the non-volatile memory of the IC card 2.

That is to say, the hardware of the H/W layer 41 is controlled by the card OS 51 of the OS layer 42. The card OS 51 of the OS layer 42 controls the operations of the hardware according to requests from the applications of the application layer 43. The process results of the hardware of the H/W layer 41 are supplied to the applications via the card OS 51 of the OS layer 42. For example, a command from an external apparatus is received by the hardware of the H/W layer 41, and is supplied to the card OS 51 of the OS layer 42. In the card OS 51, the command received by the H/W layer 41 is supplied selectively to a specified application on the application layer 43.

For example, when the H/W layer 41 receives an application selection command from an external apparatus, the card OS 51 is brought the application specified by the application selection command from the application layer 43 into a current state. When the H/W layer 41 receives the command from the external apparatus in this state, the card OS 51 supplies the command to the application in the current state. As a result, the applications of the application layer 43 execute the processes according to the commands supplied from the card OS 51 of the OS layer 42, respectively. That is to say, the card OS 51 specifies the application in the current state (hereinafter, the current application), and supplies the command to the current application.

The logical channel management function 52 is described below.

FIGS. 18 and 19 are diagrams illustrating structure examples of the channel management table 52a.

That is to say, as shown in FIGS. 18 and 19, the channel management table 52a stores access orders of the logical channels for the respective applications and files therein. That is to say, the access orders to be stored in the channel management table 52a are the orders of the logical channels set where the files or the applications are current-set (namely, the orders of the logical channels accessing to the files or the applications).

Therefore, in the channel management table 52a shown in FIG. 18, the application A is current-set in the order of logical channels “ch.1” and “ch.0”. In the channel management table 52a shown in FIG. 18, the application A and the file A1 are current-set in the logical channel “ch.1”. In the channel management table 52a shown in FIG. 18, the application B is current-sent in the logical channel “ch.2”.

For example, in the state shown in FIG. 18, a process for selecting the file A1 of the application A (the application A and the file A1 are current-set in the logical channel “ch.2” is executed in the logical channel “ch.2”. In this case, the logical channel management function 52 make the state of the channel management table 52a transit to the state shown in FIG. 19.

That is to say, the logical channel management function 52 deletes the logical channel “ch.2” from the access order for the application B in the channel management table 52a. At the same time, the logical channel management function 52 adds the logical channel “ch.2” to respect bottoms of the access orders for the application A and the file A1 in the channel management table 52a. As a result, in the channel management table 52a, the application A and the file A1 are current-set at the last in the logical channel “ch.2”, as shown in FIG. 19. According to the channel management table 52a shown in FIG. 19, when it is desired that the logical channel “ch.2” accesses to the file A1, the access order of the logical channel “ch.2” can be discriminated as being next to the logical channel “ch.1”.

In the logical channel management function 52 of the card OS 51, the channel number in which a process is executed is posted to the respective applications, or the priority rights of the logical channels for the files and the applications (access orders) are posted as the channel management table 52a. As a result, the applications which receive the commands can determine process contents of the command based on information representing the priority right given by the card OS 51.

The commands are given from the IC card processing apparatus 1 to the applications via the card OS 51. In this case, the applications determine whether the processes for the received commands are executed based on the priority order of their logical channels. In the applications, a determination may be made whether the processes for the commands are executed based on the priority order of their logical channels and the types of the received commands. In other words, the determination whether the received commands are executed is determined by the applications based on information representing the access order (priority right) of the logical channels presented by the card OS 51.

When the priority order of the logical channel is the highest in the application which receives the command, the application determines that the processes for all the commands are executable. When the priority order of the logical channel of the application which receives the command is not the highest, a determination is made that the process for the command for changing the file state (for example, the rewriting or erasing command) is non-executable. When the priority order of the logical channel of the application receiving the command is not the highest, a determination is made that the process for the command for unchanging the file state (for example, the reading command) is executable.

The process contents (executability/non-executability) for the received command can be determined by an application. Therefore, the processes realized by the applications, respectively, have the following various modes regardless of the above examples.

For example, a specific application (an application of the first order) may always execute the processes for all the commands regardless of the priority order of the logical channels. The processes for all the commands may not be executed in the logical channels other than the topmost logical channel regardless of types of received commands. Further, the writing process may be permitted for a specific file which successively stores data such as history information in record unit regardless of the priority order of the logical channels.

The IC card 2 can be freely designed so as to be provided with process contents for the commands where current setting conflicts in the logical channels in respective applications. As a result, the system having high degree of freedom according to operation modes can be realized.

The process in the IC card for a command from the IC card processing apparatus 1 is described below.

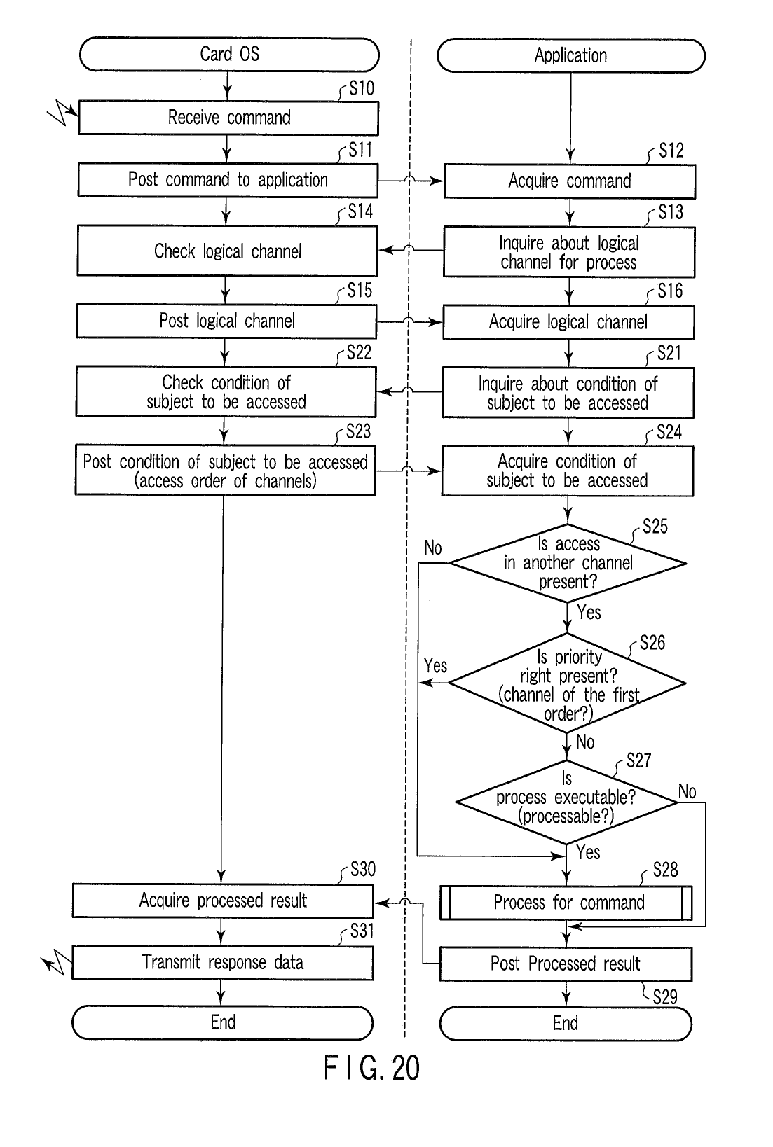

FIG. 20 is a flow chart describing a process example in the IC card for the command from the IC card processing apparatus 1. The operations of the card OS 51 and the applications are realized by the control section 20. In the following process example, the operation of the card OS 51 and the operations of the applications 61 (61A, 61B, . . . ) are described separately.

When the communication interface 22 receives a command from the IC card processing apparatus 1 (step S10), the card OS 51 which is executed by the control section 20 posts the received command to an application (application 61A) (step S11).

When acquiring the command from the card OS 51 (step S12), the application 61A inquires at the card OS 51 about a self logical channel (step S13).

In response to the inquiry, the card OS 51 refers to the channel management table 52a using the logical channel management function 52, and discriminates a logical channel of the application 61A (step S14). When the logical channel of the application 61A is discriminated, the card OS 51 posts information representing the logical channel to the application 61A (step S15).

As a result, the application 61A checks the self logical channel. The method for checking a self logical channel allocated to an application which receives a command is not limited to the process at steps S13 to S16. A method for directly checking from “CLASS” of the received command (information included in the command), or a method for acquiring it by dedicated API prepared by a card specification can be applied.

When acquiring the information representing the self logical channel from the card OS 51, the application 61A discriminates a file to be accessed to in the command. When discriminating the file to be accessed to, the application A inquires at the card OS 51 about an access condition of the file to be accessed by each logical channel (step S21).

In response to this inquiry, the card OS 51 refers to the channel management table 52a using the logical channel management function 52, and discriminates an access order (priority order) of the logical channels for the file to be accessed (step S22). When discriminating the access order of the logical channels for the file to be accessed, the card OS 51 posts information representing the access order of the logical channels for the file to the application 61A (step S23).

When acquiring the information representing the access order of the logical channels for the file to be accessed (step S24), the application 61A executes a process for determining whether the process for the command is executed (steps S25 to S26). That is to say, the application 61A determines whether another logical channel which accesses to the file to be accessed in the command is present (this file is currently set) (step S25).

When determining that another logical channel does not access to the file (No at S25), the application 61A executes the process for the command (step S28), and posts the processed result to the card OS 51 (step S29). In the process for the command at step S28, the application 61A realizes an access to a memory storing this file in cooperation with the card OS 51.

When determining that another logical channel accesses to the file (No at step S25), the application 61A determines whether the self logical channel has the priority right of the file based on the information representing the access order of the logical channels acquired from the card OS 51 (step S26). For example, the application 61A determines whether the self logical channel is in the highest order in the access order of the logical channels acquired from the card OS 51 so as to determine whether the logical channel has the priority right of the file.

When the determination is made that the self logical channel has the priority right (YES at step S26), the application 61A executes the process for the command (step S28), and posts the processed result to the card OS 51 (step S29).

When the determination is made that the self logical channel does not have the priority right (NO at step S26), the application 61A determines whether the type of the command is executable (step S27). In the process at step S27, the determination is made according to the settings of the applications. For example, the writing command is made to be non-executable and the reading command is made to be executable. All the command are made to be non-executable or executable. Further, the executability/non-executability may be determined according to types of files to be accessed.

For example, in the application 61A, a rewriting command which rewrites a file state is made to be non-executable, and the other commands are made to be executable. In this case, when the received command is the rewriting command, the application 61A determines that the process for the command is non-executable. When the received command is the reading command, the application 61A determines that the process for the command is executable.

When the determination is made that the process for the received command is executable (YES at step S27), the application 61A executes the process for the command (step S28), and posts the processed result to the card OS 51 (step S29). When the determination is made that the process for the received command is non-executable (NO at step S27), the application 61A interrupts the process for the command. When interrupting the process for the command, the application A posts information the interruption of the process for the command as the processed result to the card OS 51 (step S29).

When acquiring the process for the received command from the application 61A (step S30), the card OS 51 transmits the processed result posted from the application 61A as response data to the received command to the IC card processing apparatus 1 (step S31).

In the card OS 51 of the IC card 2, the channels current-set for the files and the access order of these channels are managed. The applications check if “a file for another channel is already current-set” and “which channels has the access priority right (access order)” as to the file to be accessed according to a received command based on information provided by the card OS 51.

The above processes enable the access control according to the current setting in a plurality of channels in the IC card. That is to say, in the command process of a certain application, the card OS 51 can check whether a file to be accessed is current-set in another channel. As a result, the process for the file current-set in a plurality of channels can be managed securely.

Concrete examples of the process in the IC card 2 are described below.

A first concrete example of the process in the IC card 2 is described. In the first concrete example, a process example for the rewriting command by means of an application, which is designed to disable rewriting when no priority right is provided (the access order is not topmost) is described. A case where the logical channels are in the state shown in FIG. 19 is assumed.

The application A receives the command for rewriting data of the file A in “ch.2”. As a result, the application A acquires a self logical channel number from the card OS 51. The application A acquires information representing an access condition of the logical channels for the file A1 as the file to be accessed (the access order of the logical channels) from the card OS 51.

When the channel management table 52a is in the state shown in FIG. 19, the application A acquires information that the channel “ch.1” is already current-set and the access order is “ch.1, “ch.2” from the card OS 51. According to such information, the application A determines that the channel “ch.1” has the priority right. Therefore, since the channel “ch.2” does not have the priority right of the rewriting process for the file A1, the application A in channel “ch.2” does not execute the rewriting process and ends the command process.

A second concrete example in the IC card 2 is described below. The second concrete example describes a process example for the reading command by the application designed to permit the execution of the reading process which does not change the file state even when the priority right is not given (when the access order is not topmost). The case where the logical channels are in the state shown in FIG. 19 is assumed.

The application A receives the command for reading the data of the file A1 in the channel “ch.2”. As a result, the application A acquires a self logical channel number from the card OS 51. The application A acquires information showing the access condition of the logical channels for the file A1 as the file to be accessed (the access order of the logical channels) from the card OS 51.

When the channel management table 52a is in the state shown in FIG. 19, the application A acquires information that the channel “ch.1” is already current-set and the access order is “ch.1”, “ch.2” from the card OS 51. According to such information, the application A determines that the channel “ch.1” has the priority right. The application A in the channel “ch.2” determines that the priority right of the file A1 is not provided but the reading command process does not change the state of the file A1 (namely, does not influence the process in the channel “ch.1”), and executes the reading process on the file A1 according to the reading command.

In the IC card 2, the operating system 51 and the applications 61A and 61B with which the process can be executed in a plurality of logical channels operate. The operating system 51 manages information representing the channels which are currently accessing to the files stored in the nonvolatile memory 25 in the channel management table 52a. The information managed in the channel management table 52a is provided to the applications 61A and 61B which process the command from the operation system 51 according to inquiries from the applications 61A and 61B. The application 61A or 61B determines whether the command processes are executable based on the information provided from the operation system 51.

As a result, the secure access control in a plurality of channels can be realized in the IC card 2. As a result, the IC card 2, whose process contents of the commands when the current setting conflicts with another logical channels can be designed according to the operation modes of the respective applications, can be provided.

The portable electronic apparatus such as the IC card which executes the process for a command to be given from an external apparatus includes a communication section, a storage section, a management section, a providing section, a determining section, an interrupting section, and an executing section. The communication section communicates with an external apparatus using a plurality of channels. The storage section stores a plurality of files therein. The management section manages information representing channels accessing to the files stored in the storage section. The providing section refers to the information managed by the management section, and provides information, which represents the channels accessing to the file to be accessed by the command received by the communication section, to the application which executes the command process. The determining section determines whether the command process is executed based on the information provided to the application by the providing section and the channel allocated to the application. The interrupting section interrupts the command process when the application determines that the command process is not executed. The executing section executes the command process when the application determines that the command process is executed.

In the portable electronic apparatus such as the IC card, the efficient access control can be realized in a plurality of channels. In the portable electronic apparatus, when a command is such that current setting (the accessing file) conflicts with another logical channel, the process contents for the command can be designed according to operating modes of applications.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A portable electronic apparatus which executes a process for a command to be given from an external apparatus, comprising:
a communication section which communicates with the external apparatus in a plurality of channels;
a storage section which stores definition information of a file and a file which is defined by the definition information therein;
a setting section which sets information representing a channel having a priority right of an access to the file as the definition information about the file;
a first processing section which, when a channel of a command for requesting the access to the file received by the communication section is the channel having the priority right of the access to the file, executes a process requested by the command on the file; and
a second processing section which, when the channel of the command for requesting the access to the file received by the communication section is a channel which does not have the priority right of the access to the file, executes a process for only a command whose process contents are permitted under predetermined access limitation.

2. The portable electronic apparatus according to claim 1, wherein when receiving a file selecting command from the communication section and a priority right of the file selected by the command is not set, the setting section sets the priority right of the access to the file for the channel of the command.

3. The portable electronic apparatus according to claim 1, further comprising a posting section which, when a command for selecting a file to be accessed is received and a channel of the command does not have a priority right of the access to the file, posts limiting of the access to the file in this channel.

4. The portable electronic apparatus according to claim 1, further comprising a setting change section which, when a channel to which the priority right is given is closed, changes the priority right of the access to the file from this channel into another channel which selects the file.

5. The portable electronic apparatus according to claim 1, further comprising a notifying section which, when a command for requesting an access to a file whose priority right is not set is received, notifies a state that the priority right of the access to the file can be set in the channel of the command.

6. The portable electronic apparatus according to claim 1, further comprising a responding section which posts processed contents in another channel having the priority right of the file to be accessed by the command as a response to the command of the channel without the priority right.

7. A portable electronic apparatus control method comprising:
setting information representing a channel having a priority right of an access to a file as definition information about the file;
when a channel of a command requesting for accessing to the file is a channel having a priority right of the access to the file, executing a process required by the command on the file; and
when the channel of the command for requesting the access to the file is a channel without the priority right of the access to the file, executing a process for only a command of process contents allowed under predetermined access limit on the file.

8. A portable electronic apparatus comprising:
a first storage section which stores an operating system program therein;
a second storage section which stores application programs therein;
a third storage section which stores data to be used in the application programs stored in the second storage section therein; and
a control section which executes the operating system program stored in the first storage section and the application program stored in the second storage section,
wherein the operating system program includes:
a management function which manages information representing a channel accessing to each file stored in the third storage section; and
a providing function which refers to the information managed by the management function so as to provide the information representing the channel accessing to the file to an application which tries to access to a specified file,
the application programs include:
a determining function which determines accessibility/inaccessibility to the file based on the information provided by the operating system and a channel allocated to the application program;
an interrupting function which, when the determining function determines that the access to the file is disabled, interrupts the access to the file; and
an executing function which, when the determining function determines that the access to the file is permitted, executes the access to the file.

9. The portable electronic apparatus according to claim 8, wherein
the management function manages the information representing channels accessing to files stored in the second storage section and access orders of the files;
the providing function refers to the information managed by the managing function so as to provide information representing the channel accessing to a file to be accessed and an access order of the file to be accessed by the channels to an application which executes the command.

10. The portable electronic apparatus according to claim 8, wherein when a head of the access order to the file to be accessed is a channel allocated to this application, the determining function determines that the access to the file is permitted.

11. The portable electronic apparatus according to claim 8, wherein when another channel which is accessing to the file to be accessed is present in a process for changing a state of the file to be accessed, the determining function determines that the file is inaccessible.

12. The portable electronic apparatus according to claim 8, wherein in a process where the state of the file to be accessed is not changed, the determining function determines that access to the file is permitted regardless of presence/non-presence of the channel accessing to the file to be accessed.
